(19) United States
(12) Patent Application Publication
(10) Pub. No.: US 2025/0308188 A1
(43) Pub. Date: Oct. 2, 2025

(54) Posture Editing Techniques for Virtual Characters

(71) Applicant: Tencent Technology(Shenzhen) Company Limited, Shenzhen (CN)

(72) Inventors: Yingting Zhu, Shenzhen (CN); Danxing Xu, Shenzhen (CN); Liang Kang, Shenzhen (CN)

(21) Appl. No.: 19/233,118

(22) Filed: Jun. 10, 2025

Related U.S. Application Data
(63) Continuation of application No. PCT/CN2024/096933, filed on Jun. 3, 2024.

(30) Foreign Application Priority Data
Jun. 10, 2023 (CN) 2023107499876

(51) Int. Cl. G06T 19/20; A63F 13/52; A63F 13/55

(52) U.S. Cl. CPC G06T 19/20; A63F 13/52; A63F 13/55; G06T 2200/24; G06T 2219/2004; G06T 2219/2016

(57) ABSTRACT

Techniques for posture editing are described herein. One technique may include displaying a posture editing interface in response to a posture creation request, the posture editing interface including a virtual object template; controlling a posture of the virtual object template to change based on a posture editing operation performed on the virtual object template in the posture editing interface, so that the virtual object template is in a first posture; and displaying, in response to a posture application request for applying the posture of the virtual object template to a target virtual object, the target virtual object in the first posture in an object display interface of the target virtual object based on posture data. Through this application, users can set the posture of the target virtual object displayed in the object display interface, thereby improving flexibility of the posture of the virtual object and enhancing a display effect of the virtual object.

### CROSS-REFERENCE TO RELATED APPLICATIONS

This application is a Continuation Application of PCT Application No. PCT/CN2024/096933, filed Jun. 3, 2024, which claims priority to Chinese Patent Application No. 2023107499876, filed Jun. 21, 2023, each entitled “POSTURE EDITING METHOD AND APPARATUS FOR VIRTUAL OBJECT, COMPUTER DEVICE, AND PROGRAM PRODUCT”and each of which is incorporated herein by reference in its entirety.

### FIELD

Aspects described herein relate to the field of computer technologies, and in particular, to posture editing of a virtual object such as a virtual character.

### BACKGROUND

With development of computer technologies and multimedia technologies, increasing electronic games emerged, greatly enriching people's daily life. Electronic games provide virtual objects, and users may control these virtual objects to engage in battles in the electronic games.

To help users learn about virtual objects, virtual objects of the users may be displayed in an object display interface. However, the virtual objects are usually in a fixed preset posture in an electronic game, resulting in a single and inflexible display effect.

### SUMMARY

Aspects described herein provide a posture editing method and apparatus for a virtual object, a computer device, and a storage medium, which improve flexibility of postures of the virtual object and enhance a display effect of the virtual object. The technical solutions are as follows.

According to an aspect, a posture editing method for a virtual object is provided, including:
displaying a posture editing interface in response to a posture creation request, the posture editing interface including a virtual object template;
controlling a posture of the virtual object template to change based on a posture editing operation performed on the virtual object template in the posture editing interface, so that the virtual object template is in a first posture; and
displaying, in response to a posture application request for applying the posture of the virtual object template to a target virtual object, the target virtual object in the first posture in an object display interface of the target virtual object.

According to another aspect, a posture editing apparatus for a virtual object is provided, including:
an interface display module, configured to display a posture editing interface in response to a posture creation request, the posture editing interface including a virtual object template;
a posture editing module, configured to control a posture of the virtual object template to change based on a posture editing operation performed on the virtual object template in the posture editing interface, so that the virtual object template is in a first posture; and
a posture application module, configured to display, in response to a posture application request for applying the posture of the virtual object template to a target virtual object, the target virtual object in the first posture in an object display interface of the target virtual object.

According to another aspect, a computer device is provided, the computer device including a processor and a memory, the memory having at least one computer program stored therein, the at least one computer program being loaded and executed by the processor to implement the operations performed in the posture editing method for a virtual object in the foregoing aspect.

According to another aspect, a computer-readable storage medium is provided, the computer-readable storage medium having at least one computer program stored therein, the at least one computer program being loaded and executed by a processor to implement the operations performed in the posture editing method for a virtual object in the foregoing aspect.

According to another aspect, a computer program product is provided, including a computer program, the computer program being loaded and executed by a processor to implement the operations performed in the posture editing method for a virtual object in the foregoing aspect.

According to the solutions provided in the aspects described herein, a user may first edit a customized posture by using a virtual object template, perform a posture editing operation on the virtual object template, to flexibly generate various postures, and subsequently apply the generated posture to a target virtual object controlled by the user, to display the target virtual object in the customized posture in an object display interface. Therefore, the user can flexibly set the posture of the target virtual object displayed in the object display interface, which improves flexibility of the posture of the virtual object during display of the virtual object and enhances a display effect of the virtual object.

### BRIEF DESCRIPTION OF THE DRAWINGS

FIG. 1 is a schematic diagram of an implementation environment according to an aspect described herein.

FIG. 2 is a flowchart of a posture editing method for a virtual object according to an aspect described herein.

FIG. 3 is a flowchart of another posture editing method for a virtual object according to an aspect described herein.

FIG. 4 is a schematic diagram of a posture editing interface according to an aspect described herein.

FIG. 5 is a schematic diagram of another posture editing interface according to an aspect described herein.

FIG. 6 is a schematic diagram of another posture editing interface according to an aspect described herein.

FIG. 7 is a schematic diagram of another posture editing interface according to an aspect described herein.

FIG. 8 is a schematic diagram of another posture editing interface according to an aspect described herein.

FIG. 9 is a schematic diagram of another posture editing interface according to an aspect described herein.

FIG. 10 is a schematic diagram of another posture editing interface according to an aspect described herein.

FIG. 11 is a schematic diagram of a posture setting interface according to an aspect described herein.

FIG. 12 is a schematic diagram of an object display interface according to an aspect described herein.

FIG. 13 is a flowchart of another posture editing method for a virtual object according to an aspect described herein.

FIG. 14 is a schematic diagram of a posture management interface according to an aspect described herein.

FIG. 15 is a schematic diagram of a detail interface according to an aspect described herein.

FIG. 16 is a schematic diagram of a confirmation interface according to an aspect described herein.

FIG. 17 is a flowchart of another posture editing method for a virtual object according to an aspect described herein.

FIG. 18 is a schematic diagram of another posture editing interface according to an aspect described herein.

FIG. 19 is a schematic structural diagram of a posture editing apparatus for a virtual object according to an aspect described herein.

FIG. 20 is a schematic structural diagram of another posture editing apparatus for a virtual object according to an aspect described herein.

FIG. 21 is a schematic structural diagram of a terminal according to an aspect described herein.

FIG. 22 is a schematic structural diagram of a server according to an aspect described herein.

### DETAILED DESCRIPTION

To make objectives, technical solutions, and advantages of aspects described herein clearer, implementations described herein are described below in further detail with reference to drawings.

Terms “first”, “second”, and the like used in this application may be configured for describing various concepts in this specification. However, unless otherwise specified, these concepts are not limited by these terms. These terms are merely configured for distinguishing one concept from another. For example, without departing from the scope described herein, a first posture may be referred to as a second posture, and similarly, the second posture may be referred to as the first posture.

“At least one” refers to one or more. For example, “at least one virtual object” may include virtual objects of any integer number greater than or equal to one, such as one virtual object, two virtual objects, or three virtual objects. “A plurality of” refers to two or more. For example, “a plurality of virtual objects” may include virtual objects of any integer number greater than or equal to two, such as two virtual objects or three virtual objects. “Each” refers to every one of “at least one”. For example, “each virtual object” refers to every virtual object of “a plurality of virtual objects”. If “a plurality of virtual objects” include three virtual objects, “each virtual object” refers to every virtual object of the three virtual objects.

The implementations described herein involve data related to virtual object templates, target virtual objects, and posture data. When the foregoing aspects described herein are applied to specific products or technologies, such application is conducted under user authorization and consent or full authorization of all relevant parties, and collection, use, and processing of the related data need to comply with relevant laws, regulations, and standards of relevant countries and regions.

A virtual scene involved in this application may be configured for simulating a three-dimensional virtual space, which may be an open space. For example, the virtual scene may include sky, land, and ocean. The land may include environmental elements such as a desert and a city. Certainly, the virtual scene may further include virtual items, such as a projectile, a building, a vehicle, and a prop such as a virtual weapon for a virtual object in the virtual scene to equip himself or engage in a battle with other virtual objects. The virtual scene may be further configured for simulating environments under different weather conditions, such as sunny, rainy, foggy, or nighttime. Various scene elements enhance diversity and a realistic effect of the virtual scene.

A user controls the virtual object to move in the virtual scene. The virtual object is a virtual image in the virtual scene configured for representing the user. The virtual image may be in any form, such as a human or an animal, which is not limited in this application. An electronic game is used as an example. The electronic game may be a first-person shooting game, a third-person shooting game, or another electronic game of a long-distance battle with virtual weapons. A shooting game is used as an example. The user may control the virtual object to fall freely, glide, or open a parachute for falling in the sky in the virtual scene, or to run, jump, creep, or move forward in a bent state on the land, or to swim, float, or dive in the ocean. Certainly, the user may further control the virtual object to ride in a virtual vehicle to move in the virtual scene. The user may further control the virtual object to enter and exit a building in the virtual scene, and discover and pick up a virtual item in the virtual scene and then engage in a battle with other virtual objects by using the picked virtual item. For example, the virtual item may be virtual clothing, a virtual helmet, a virtual bulletproof vest, a virtual medical product, or a virtual weapon, or may be a virtual item left by another virtual object that is eliminated. The foregoing scenarios are provided for illustrative purposes only, and no limitation is imposed in the aspects described herein.

An electronic game scenario is used as an example in the aspects described herein. A user performs an operation in advance on a terminal. After detecting the operation of the user, the terminal downloads a game configuration file of the electronic game. The game configuration file includes an application program, interface display data, or virtual scene data of the electronic game. Therefore, when the user logs into the electronic game on the terminal, the user may invoke the game configuration file to render and display an interface of the electronic game. The user performs a touch operation on the terminal. After detecting the touch operation, the terminal determines game data corresponding to the touch operation, and renders and displays the game data. The game data includes virtual scene data, behavior data of a virtual object in the virtual scene, and the like.

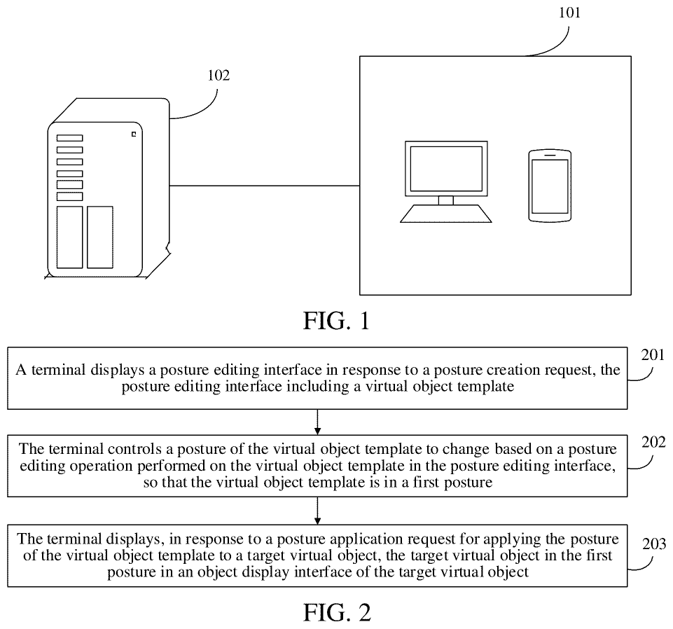

FIG. 1 is a schematic diagram of an implementation environment according to an aspect described herein. As shown in FIG. 1, the implementation environment includes a terminal 101 and a server 102. The terminal 101 and the server 102 are directly or indirectly connected through wired or wireless communication, which is not limited in this application.

In the aspects described herein, the server 102 provides a virtual object for a terminal 101, and the terminal 101 displays the virtual object provided by the server 102. The server 102 is configured to perform background processing based on a trigger operation detected by the terminal 101 to provide background support for the terminal 101, such as editing a posture of the virtual object.

In a possible implementation, a game application for which the server 102 provides services is installed on the terminal 101, and the terminal 101 interacts with the server 102 through the game application. The game application can provide a gaming function. In some aspects, the server 102 is a backend server for the game application or a cloud server providing services such as cloud computing and cloud storage.

In a possible implementation, the terminal 101 is a smartphone, a tablet computer, a notebook computer, a desktop computer, a smart speaker, a smart television, a smart watch, or an on-board terminal, but is not limited thereto. In some aspects, the server 102 is an independent physical server. Alternatively, the server 102 is a server cluster or a distributed system formed by a plurality of physical servers. Alternatively, the server 102 is a cloud server that provides basic cloud computing services such as a cloud service, a cloud database, cloud computing, a cloud function, cloud storage, a network service, cloud communication, a middleware service, a domain name service, a security service, a content delivery network (CDN), a big data platform, and an artificial intelligence (AI) platform.

A posture editing method for a virtual object provided in the aspects described herein may be applied to any scenario in which the virtual object is displayed.

For example, in a game application, a user has a virtual object configured for control and operation by the user, and the virtual object of the user may be displayed in an object panel or a lobby interface. During display of the virtual object, the virtual object is in a preset posture in the game application. If the user thinks that the preset posture of the virtual object is single, the user may use the method provided in the aspects described herein. The user may manually edit a posture and apply the customized posture to the virtual object of the user, so that the virtual object is in the customized posture during display of the virtual object in the object panel or the lobby interface. In this way, the display of the virtual object is more personalized, thereby improving a display effect of the virtual object.

FIG. 2 is a flowchart of a posture editing method for a virtual object according to an aspect described herein. This aspect described herein is executed by a computer device. The computer device is the terminal in the foregoing implementation environment shown in FIG. 1, for example. Referring to FIG. 2, the method includes the following operations.

201: The terminal displays a posture editing interface in response to a posture creation request, the posture editing interface including a virtual object template.

The terminal provides a virtual object, which may be displayed in a display interface of the virtual object for viewing by a user. During display of the virtual object, a posture of the virtual object may be a preset posture. In this aspect described herein, the posture of the virtual object may be customized through posture editing.

If the user wants to customize the posture of the virtual object, the user performs a posture creation operation to trigger the posture creation request. The terminal displays the posture editing interface in response to the posture creation request, which is configured for editing the posture of the virtual object. The posture editing interface includes the virtual object template, which is a model configured for posture editing. The user performs posture editing on the virtual object template. The posture of the virtual object template may subsequently be applied to another virtual object.

In a possible implementation, the terminal runs a target application, which provides virtual objects. For example, the target application is a game application configured for electronic gaming. Various users control virtual objects to engage in game battles in the game application. The game application includes virtual objects configured for control and operation by the users and virtual objects not configured for control and operation by the users.

202: The terminal controls a posture of the virtual object template to change based on a posture editing operation performed on the virtual object template in the posture editing interface, so that the virtual object template is in a first posture.

The user performs the posture editing operation on the virtual object template in the posture editing interface. The terminal controls, based on the posture editing operation performed by the user, the posture of the virtual object template to change as indicated by the posture editing operation. The virtual object template after the change is in the first posture. The first posture is a posture obtained after the posture of the virtual object template is changed based on the posture editing operation.

The posture editing operation is configured for adjusting and editing the posture of the virtual object template, so as to change the posture of the virtual object template to a posture required by the current posture editing operation, for example, the first posture.

203: The terminal displays, in response to a posture application request for applying the posture of the virtual object template to a target virtual object, the target virtual object in the first posture in an object display interface of the target virtual object.

After the user causes the virtual object template to be in the first posture by performing the posture editing operation, the user obtains the customized first posture. The user may apply the posture of the virtual object template to the target virtual object, that is, apply the first posture to the target virtual object. Applying the first posture to the target virtual object means that the target virtual object is in the first posture during the display of the target virtual object in the object display interface. If the user wants to apply the posture of the virtual object template to the target virtual object, the user performs the posture application operation to apply the posture of the virtual object template to the target virtual object, to trigger the posture application request. The terminal displays the target virtual object in the first posture in the object display interface in response to the posture application request.

The object display interface may be a lobby interface of the game application, an attribute panel interface of the target virtual object, or the like, which is not limited in this aspect described herein.

According to the method provided in this aspect described herein, the user may first edit a customized posture by using the virtual object template, perform the posture editing operation on the virtual object template, to flexibly generate various postures, and subsequently apply the generated posture to the target virtual object controlled by the user, to display the target virtual object in the customized posture in the object display interface. Therefore, the user can flexibly set the posture of the target virtual object displayed in the object display interface, which improves flexibility of the posture of the virtual object during display of the virtual object and enhances a display effect of the virtual object.

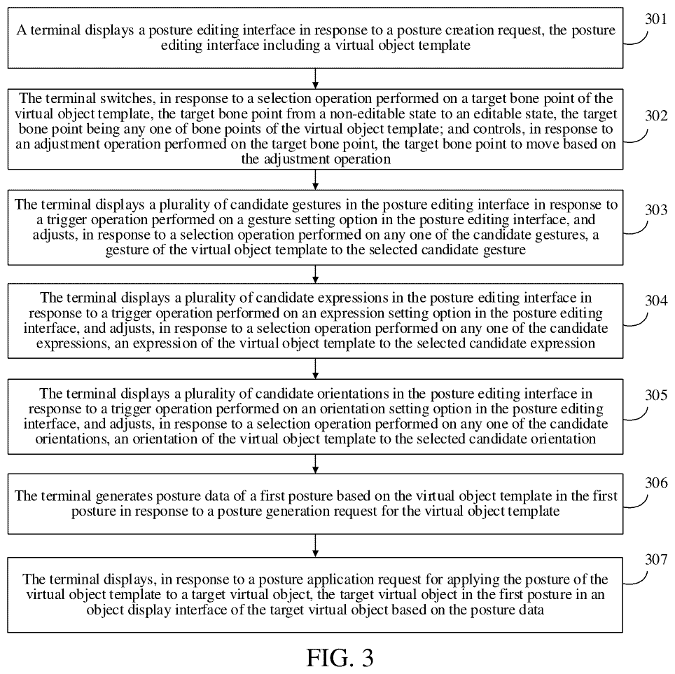

In the foregoing aspect shown in FIG. 2, the posture editing method for a virtual object is briefly described. In the posture editing method for a virtual object, for a detailed process of posture editing and a detailed process of posture application, reference may be referred to the following aspect shown in FIG. 3. FIG. 3 is a flowchart of a posture editing method for a virtual object according to another aspect described herein. This aspect described herein is executed by a computer device. The computer device is the terminal in the foregoing implementation environment shown in FIG. 1, for example. Referring to FIG. 3, the method includes the following operations.

301: The terminal displays a posture editing interface in response to a posture creation request, the posture editing interface including a virtual object template.

The terminal provides a virtual object. If a user wants to customize a posture of the virtual object, the user performs a posture creation operation to trigger the posture creation request. The terminal displays the posture editing interface in response to the posture creation request.

In a possible implementation, the terminal displays a posture management interface, the posture management interface including a posture creation option and generated postures. The terminal displays the posture editing interface in response to a trigger operation performed on the posture creation option.

In this aspect described herein, the posture management interface provides the posture creation option. If the user wants to create a customized posture, the user performs the trigger operation on the posture creation option. The terminal switches from the posture management interface to the posture editing interface in response to the trigger operation performed on the posture creation option, so that the user performs posture editing on the virtual object template in the posture editing interface.

In a possible implementation, the terminal displays a plurality of candidate postures in the posture editing interface in response to the posture creation request, and displays, in response to a selection operation performed on any one of the candidate postures, a virtual object template in the selected candidate posture in the posture editing interface.

When the user creates a posture, the terminal provides a plurality of candidate postures for the user. The user may select one candidate posture from the plurality of candidate postures as an initial posture of the virtual object template, and then edit the posture of the virtual object template based on the initial posture.

In this aspect described herein, the user may select one candidate posture from the plurality of candidate postures provided by the terminal as an initial posture for posture editing, so that the user may make simple adjustment based on the candidate posture to achieve a desired effect, thereby reducing difficulty of posture editing for the user. Alternatively, the user may make secondary creation through imagination based on the candidate posture, thereby enhancing fun in creating a customized posture for the user.

In a possible implementation, the terminal displays a plurality of candidate body shapes in the posture editing interface in response to the posture creation request, and displays, in response to a selection operation performed on any one of the candidate body shapes, the virtual object template in the selected candidate body shape in the posture editing interface.

When the user creates a posture, the terminal provides a plurality of candidate body shapes for the user. The candidate body shapes refer to body shapes of the virtual object template. For example, the candidate body shapes include an adult male, an adult female, a juvenile male, a juvenile female, and a child. The user may select one candidate body shape from the plurality of candidate body shapes as a body shape of the virtual object template. For example, if the user selects the adult male body shape, the terminal displays a virtual object template in the adult male body shape in the posture editing interface.

In this aspect described herein, the user may select one candidate body shape from the plurality of candidate body shapes provided by the terminal as the body shape of the virtual object template used for posture editing, and may subsequently apply the posture of the virtual object template to another virtual object of the same body shape. For example, if the user wants to apply the customized posture to a virtual object of the juvenile female body shape, the user may select a virtual object template with the teenage female body shape for posture editing. Selectable body shapes for the virtual object template are provided for the user, so that body shapes in a posture editing phase and a posture application phase can be consistent, which helps enhance an effect of subsequently applying the posture of the virtual object template to another virtual object.

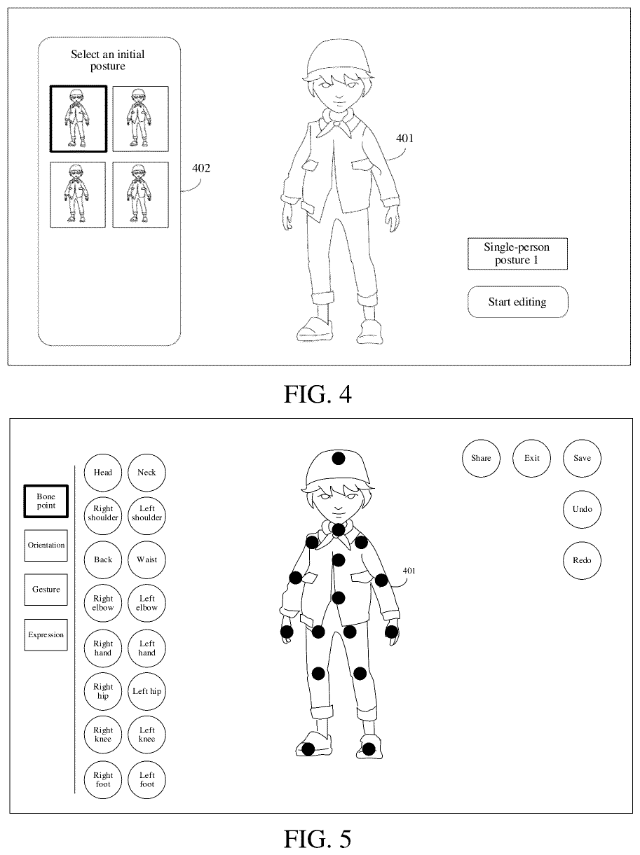

FIG. 4 is a schematic diagram of a posture editing interface according to an aspect described herein. As shown in FIG. 4, the posture editing interface includes a virtual object template 401 and a plurality of candidate postures 402. The virtual object template 401 is currently in a preset posture. If the user wants to perform editing based on the preset posture, the user may directly perform a trigger operation on a “Start editing” option. If the user wants to select a candidate posture for editing, the user may perform a selection operation on the candidate posture, so that the terminal switches a posture of the virtual object template from the preset posture to the candidate posture in the posture editing interface.

In a possible implementation, the terminal further displays bone points of the virtual object template in the posture editing interface, and drives the posture of the virtual object to change by adjusting the bone points of the virtual object. FIG. 5 is a schematic diagram of another posture editing interface according to an aspect described herein. As shown in FIG. 5, the terminal displays the virtual object template 401 in the posture editing interface, with bone points being displayed on a body of the virtual object template 401. The various bone points of the virtual object template are also displayed on a left side of the posture editing interface.

The bone points of the virtual object template do not specifically refer to body joints of a human, but are related to a structure of an object bone model of the virtual object template. The bone points are connection points or non-connection points in the object bone model that can produce displacement and rotation. The bone points may be controlled through a posture editing operation, so that a state of the object bone model, or in other words, the virtual object template, can be changed.

In this aspect described herein, after the terminal displays the posture editing interface, the user may perform the posture editing operation on the virtual object template in the posture editing interface. The terminal controls the posture of the virtual object template to change based on the posture editing operation performed on the virtual object template in the posture editing interface, so that the virtual object template is in the first posture. The process of controlling the posture the virtual object template to change based on the posture editing operation includes at least one of the following operation 302 to operation 305.

302: The terminal switches, in response to a selection operation performed on a target bone point of the virtual object template, the target bone point from a non-editable state to an editable state, the target bone point being any one of bone points of the virtual object template; and controls, in response to an adjustment operation performed on the target bone point, the target bone point to move based on the adjustment operation.

The target bone point is a bone point of the virtual object template selected by the selection operation.

The bone points of the virtual object template are further displayed in the posture editing interface. Unselected bone points of the virtual object template are in the non-editable state, and the user cannot adjust the bone points in the non-editable state. If the user wants to adjust the target bone point of the plurality of bone points, the user performs a selection operation on the target bone point. The terminal switches the target bone point from the non-editable state to the editable state in response to the selection operation, so that the user can adjust the bone point in the editable state. When the user performs an adjustment operation on the target bone point, the terminal controls, in response to the adjustment operation, the target bone point to move based on the adjustment operation. The user may further adjust the target bone point based on a movement status of the target bone point until the target bone point reaches a state desired by the user.

In this aspect described herein, the user may adjust the bone points of the virtual object template in the posture editing interface. Adjusting the bone points to drive the posture of the virtual object template to change achieves low difficulty in user operations, helps the user control the posture of the virtual object template to change, and improves convenience in customizing the posture of the virtual object template.

In a possible implementation, the terminal displays a direction indication mark in response to the selection operation performed on the target bone point, the direction indication mark being configured for indicating a moving direction allowed for the target bone point, the moving direction including at least one of a displacement direction and a rotation direction. In this aspect described herein, the terminal determines the moving direction allowed for the target bone point after the user selects the target bone point. Because movement of the target bone point includes at least one of displacement and rotation, the moving direction allowed for the target bone point includes at least one of the displacement direction and the rotation direction.

In this aspect described herein, the terminal displays the direction indication mark, to prompt the user of a moving direction in which the bone point can move through the direction indication mark, thereby guiding the user to control the bone point to move in the moving direction and assisting the user in adjusting the bone point of the virtual object template.

In some aspects, the moving direction includes a plurality of types. For example, the moving direction includes displacement in an x-axis direction, displacement in a y-axis direction, displacement in a z-axis direction, rotation about an x axis, rotation about a y axis, rotation about a z axis, and the like. The terminal has stored therein a moving direction allowed for each bone point. Each bone point has at least one moving direction, and moving directions allowed for different bone points may be the same or different. For example, some bone points may displace in the x-axis and y-axis directions but cannot displace in the z-axis direction.

In some aspects, the direction indication mark may be an indication arrow, and a direction pointed by the arrow represents the moving direction. Alternatively, the direction indication mark may be a three-axis direction indication model, a three-axis direction indication sphere, or the like, which is not limited in this aspect described herein.

In some aspects, the direction indication mark is composed of indication sub-marks of a plurality of moving directions, each indication sub-mark being configured for indicating one moving direction. The terminal cancels, in response to a drag operation performed in the posture editing interface, display of indication sub-marks other than an indication sub-mark of a target direction, the target direction being a direction of the drag operation.

When the user performs the drag operation, the movement direction of the bone point is the direction of the drag operation. Since the direction in which the user controls the bone point to move is unambiguous, there is no need to indicate other moving directions of the bone point. Therefore, the terminal displays only the indication sub-marks consistent with the direction of the drag operation and cancels the display of the indication sub-marks inconsistent with the direction of the drag operation, so that the content displayed on the posture editing interface is more concise, thereby helping the user observe the change of the bone point based on the drag operation.

In another possible implementation, the terminal controls, in response to the drag operation performed in the posture editing interface, the target bone point to move in the direction of the drag operation, the drag operation being a drag operation performed on the target bone point or a drag operation performed on a virtual joystick in the posture editing interface.

The bone points of the virtual object template are displayed on a body of the virtual object template in the posture editing interface, and the virtual joystick is further displayed in the posture editing interface. After selecting the target bone point, the user may perform a drag operation (continuously pressing and dragging the target bone point) on the target bone point, so that the target bone point moves in a direction of the drag operation performed on the target bone point. Alternatively, the user may further perform a drag operation (continuously pressing and dragging the virtual joystick) on the virtual joystick, so that the target bone point moves in a direction of the drag operation performed on the virtual joystick.

In this aspect described herein, the bone point is controlled to move through the drag operation. Controlling the bone point to move by dragging the bone point can present an effect in which the bone point is dragged to move by the user, which is vivid. Controlling the bone point to move by dragging the virtual joystick can avoid shielding of the bone point caused by directly dragging the bone point, thereby helping the user clearly observe movement change of the bone point. In this aspect described herein, the foregoing two operation manners are provided, which provide a more flexible manner for the user to control the bone point to move through the drag operation, thereby helping enhance user experience of human-computer interaction.

In a possible implementation, controlling the bone point to move by dragging the bone point includes a first mode and a second mode. Therefore, that the terminal controls, in response to the drag operation performed in the posture editing interface, the target bone point to move in the direction of the drag operation includes the following two control manners.

First control manner: The terminal determines an associated bone point of the target bone point and controls the target bone point and the associated bone point to move in response to the drag operation when the posture editing interface is in the first mode, so that the target bone point displaces based on the drag operation, the first mode being configured for controlling the bone points of the virtual object template to displace.

In the first mode, the drag operation performed on the target bone point is configured for rotating both the target bone point and the associated bone point to drive the target bone point to displace. An association relationship between the bone points may be preset in the game application. The terminal may determine the associated bone point of the target bone point by querying the association relationship between the bone points. A connection relationship exists between associated bone points. Therefore, rotation of a bone point can drive other bone points associated with the bone point to generate displacement. In this aspect described herein, the first mode may be understood as an easy mode. When the user performs the drag operation on the target bone point, the terminal rotates both the target bone point and the associated bone point through an inverse kinematics (IK) algorithm, so that the target bone point displaces based on the drag operation. Therefore, in the first mode, performing the drag operation on the target bone point causes both the target bone point and the associated bone point of the target bone point to move.

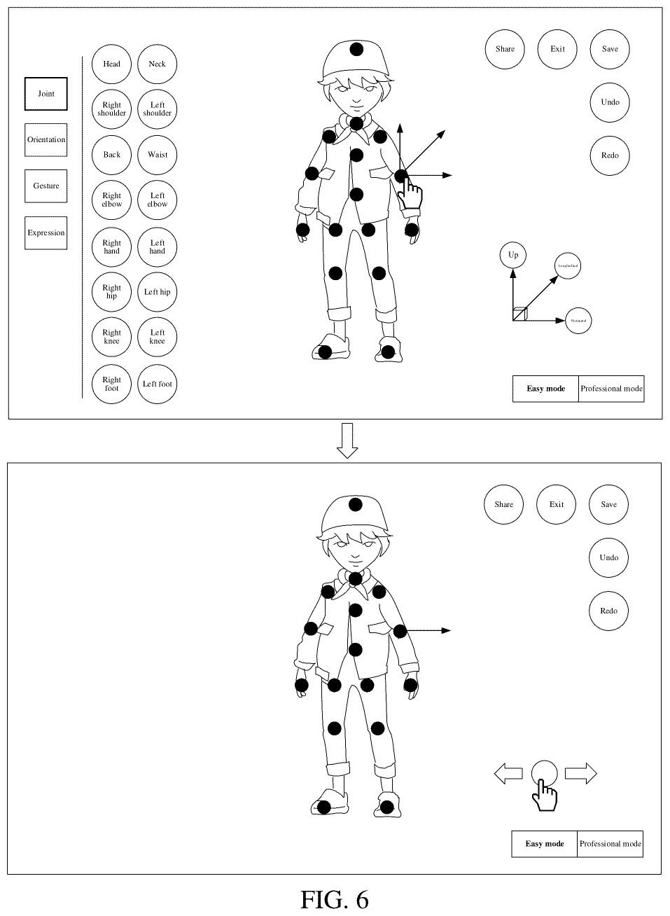

FIG. 6 is a schematic diagram of another posture editing interface according to an aspect described herein. An “Easy mode” shown in FIG. 6 is the first mode. After the user selects a target bone point, the terminal displays a direction indication mark at a position of the target bone point, and displays the direction indication mark at a position of a virtual joystick at a lower right corner of the posture editing interface. In the first mode, the direction indication mark is represented as a three-axis direction indication model, and includes indication sub-marks of three moving directions. When the user performs a drag operation (on the target bone point or on the virtual joystick), the terminal cancels display of indication sub-marks in the direction indication mark of moving directions other than a direction of the drag operation, and displays only the indication sub-mark of the direction of the drag operation.

Second control manner: The target bone point is controlled to rotate based on the drag operation in response to the drag operation when the posture editing interface is in a second mode, the second mode being configured for controlling the bone points of the virtual object template to rotate.

In the second mode, the drag operation performed on the target bone point is configured for rotating the target bone point. In this aspect described herein, the second mode may be understood as a professional mode. When the user performs a drag operation on the target bone point, the terminal causes the target bone point to rotate based on the drag operation. In the second mode, the drag operation performed on the target bone point only causes the target bone point to rotate and does not cause other bone points to move.

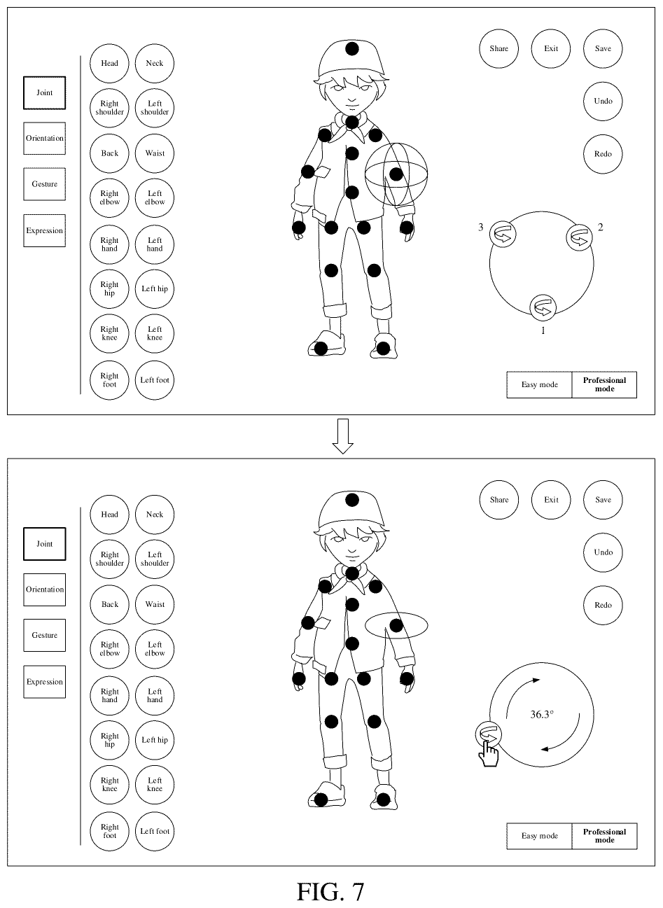

FIG. 7 is a schematic diagram of another posture editing interface according to an aspect described herein. A “Professional mode” shown in FIG. 7 is the second mode. After the user selects a target bone point, the terminal displays a direction indication mark at a position of the target bone point, and displays the direction indication mark at a position of a virtual joystick at a lower right corner of the posture editing interface. In the second mode, the direction indication mark is represented as a three-axis direction indication sphere, and includes indication sub-marks of three moving directions. When the user performs a drag operation (on the target bone point or on the virtual joystick), the terminal cancels display of indication sub-marks in the direction indication mark of moving directions other than a direction of the drag operation, and displays only the indication sub-mark of the direction of the drag operation.

In this aspect described herein, the terminal provides two bone point control manners. The first manner is the first mode, in which the drag operation is performed to cause both the currently controlled bone point and the associated bone points to rotate, so that the bone points displace based on the drag operation, thereby facilitating coarse adjustment of the bone points by a hand who does not know the bone points well. The second manner is the second mode, in which the drag operation is performed to cause the currently controlled bone point to rotate, to facilitate fine adjustment of the bone points by an experienced user who knows the bone points well.

In a possible implementation, the terminal stops, during control of any one of the bone points to rotate, controlling rotation of the bone point in a current direction in a case that a rotation angle of the bone point in the current direction reaches a rotation angle threshold of the bone point in the current direction.

In either the first mode or the second mode, if a bone point is currently being controlled to rotate, the bone point cannot be further rotated in a current direction if a rotation angle of the bone point in the current direction reaches a rotation angle threshold of the bone point in the current direction. The rotation angle threshold is a threshold preset in the game application.

In some aspects, the rotation angle threshold includes a first rotation angle threshold and a second rotation angle threshold. When the rotation angle of the bone point in the current direction reaches either the first rotation angle threshold or the second rotation angle threshold, the control of the bone point to rotate in the current direction is stopped. The first rotation angle threshold is set based on a maximum physiological angle that can be reached by the bone points of the virtual object. Setting the first rotation angle threshold can prevent the posture of the virtual object from exceeding physiological limits, prevent the user from customizing postures exceeding physiological limits, and help ensure authenticity of the posture of the virtual object. The second rotation angle threshold is set by a developer based on a maximum freedom for customizing postures. Setting the second rotation angle threshold can avoid aesthetically unpleasing postures of the virtual object, prevent the user from customizing unsightly postures, and achieve a proper limitation on a freedom in customizing postures by the user.

303: The terminal displays a plurality of candidate gestures in the posture editing interface in response to a trigger operation performed on a gesture setting option in the posture editing interface, and adjusts, in response to a selection operation performed on any one of the candidate gestures, a gesture of the virtual object template to the selected candidate gesture.

In this aspect described herein, the posture editing interface further includes a gesture setting option, and the user may further set the gesture of the virtual object template. If the user wants to adjust the gesture of the virtual object template, the user performs a trigger operation on the gesture setting option. The terminal displays a plurality of candidate gestures in the posture editing interface in response to the trigger operation performed on the gesture setting option. If the user wants to set the gesture of the virtual object template to a particular candidate gesture, the user performs a selection operation on the candidate gesture. The terminal adjusts the gesture of the virtual object template to the selected candidate gesture in response to the selection operation. The gesture of the virtual object template belongs to the posture of the virtual object template. When the posture of the virtual object template is subsequently applied to the target virtual object, a gesture of the target virtual object is adjusted to the gesture of the virtual object template.

That the terminal displays a plurality of candidate gestures in the posture editing interface may be displaying gesture names of the plurality of candidate gestures or gesture images of the plurality of candidate gestures.

In this aspect described herein, the user may further set the gesture of the virtual object template and adjust the gesture of the virtual object template based on the candidate gestures provided by the terminal, so that the user can independently set a hand action of the virtual object template, thereby making the overall posture of the virtual object template more vivid and interesting. When the posture of the virtual object template is subsequently applied to the target virtual object, the gesture of the target virtual object is synchronously adjusted to the gesture of the virtual object template, thereby making the overall posture of the target virtual object more vivid and interesting.

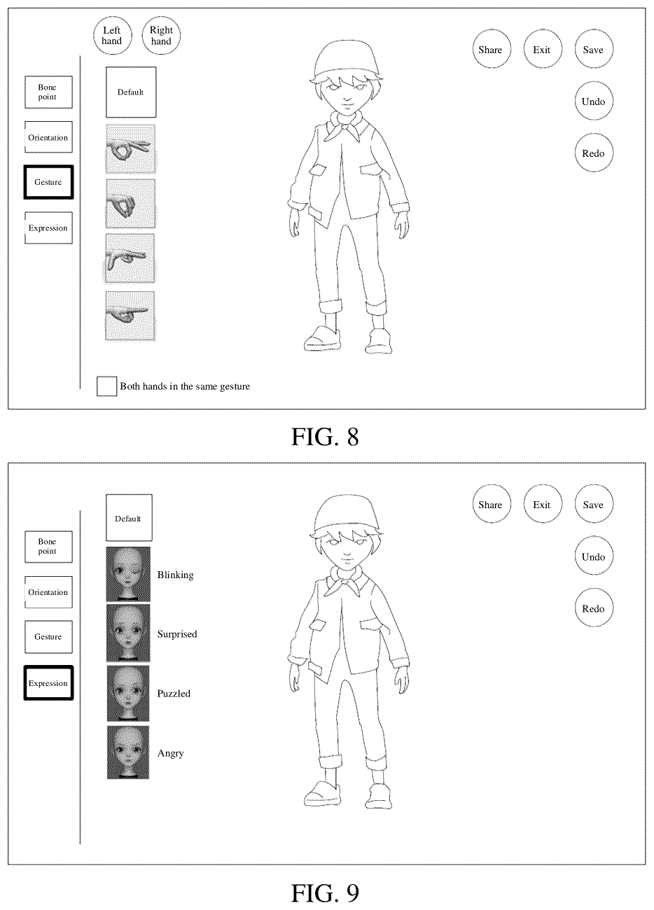

FIG. 8 is a schematic diagram of another posture editing interface according to an aspect described herein. As shown in FIG. 8, a gesture setting option labeled “Gesture” is displayed in the posture editing interface. After the user performs a trigger operation on the gesture setting option, the terminal displays the gesture images of the plurality of candidate gestures on the left side of the posture editing interface. When the user clicks/taps the gesture image of a particular candidate gesture, the terminal adjusts the gesture of the virtual object template in the posture editing interface to the selected candidate gesture.

304: The terminal displays a plurality of candidate expressions in the posture editing interface in response to a trigger operation performed on an expression setting option in the posture editing interface, and adjusts, in response to a selection operation performed on any one of the candidate expressions, an expression of the virtual object template to the selected candidate expression.

In this aspect described herein, the posture editing interface further includes an expression setting option, and the user may further set the expression of the virtual object template. If the user wants to adjust the expression of the virtual object template, the user performs a trigger operation on the expression setting option. The terminal displays a plurality of candidate expressions in the posture editing interface in response to the trigger operation performed on the expression setting option. If the user wants to set the expression of the virtual object template to a particular candidate expression, the user performs a selection operation on the candidate expression. The terminal adjusts the expression of the virtual object template to the selected candidate expression in response to the selection operation. The expression of the virtual object template belongs to the posture of the virtual object template. When the posture of the virtual object template is subsequently applied to the target virtual object, an expression of the target virtual object is adjusted to the expression of the virtual object template.

That the terminal displays a plurality of candidate expressions in the posture editing interface may be displaying expression names of the plurality of candidate expressions or expression images of the plurality of candidate expressions.

In this aspect described herein, the user may further set the expression of the virtual object template and adjust the expression of the virtual object template based on the candidate expressions provided by the terminal, so that the user can independently set a facial expression of the virtual object template, thereby making the overall posture of the virtual object template more vivid and interesting. When the posture of the virtual object template is subsequently applied to the target virtual object, the expression of the target virtual object is synchronously adjusted to the expression of the virtual object template, thereby making the overall posture of the target virtual object more vivid and interesting.

FIG. 9 is a schematic diagram of another posture editing interface according to an aspect described herein. As shown in FIG. 9, an expression setting option labeled “Expression” is displayed in the posture editing interface. After the user performs a trigger operation on the expression setting option, the terminal displays the expression images of the plurality of candidate expressions on the left side of the posture editing interface. When the user clicks/taps the expression image of a particular candidate expression, the terminal adjusts the expression of the virtual object template in the posture editing interface to the selected candidate expression.

305: The terminal displays a plurality of candidate orientations in the posture editing interface in response to a trigger operation performed on an orientation setting option in the posture editing interface, and adjusts, in response to a selection operation performed on any one of the candidate orientations, an orientation of the virtual object template to the selected candidate orientation.

In this aspect described herein, the posture editing interface further includes an orientation setting option, and the user may further set the orientation of the virtual object template. If the user wants to adjust the orientation of the virtual object template, the user performs a trigger operation on the orientation setting option. The terminal displays a plurality of candidate orientations in the posture editing interface in response to the trigger operation performed on the orientation setting option. If the user wants to set the orientation of the virtual object template to a particular candidate orientation, the user performs a selection operation on the candidate orientation. The terminal adjusts the orientation of the virtual object template to the selected candidate orientation in response to the selection operation. The orientation of the virtual object template belongs to the posture of the virtual object template. When the posture of the virtual object template is subsequently applied to the target virtual object, an orientation of the target virtual object is adjusted to the orientation of the virtual object template.

In some aspects, in addition to providing the candidate orientations, the terminal may further provide an orientation adjustment option in the posture editing interface, switch the posture editing interface to an orientation adjustment mode response to a trigger operation performed on the orientation adjustment option, and adjust the orientation of the virtual object template to a direction of a drag operation in response to the drag operation in the orientation adjustment mode.

In some aspects, the terminal displays a plurality of candidate orientations for a face in the posture editing interface, and adjusts, in response to a selection operation performed on any one of the candidate orientations for the face, an orientation of the face of the virtual object template to the selected candidate orientation. In some aspects, the terminal displays a plurality of candidate orientations for an eye in the posture editing interface, and adjusts, in response to a selection operation performed on any one of the candidate orientations for the eye, an orientation of the eye of the virtual object template to the selected candidate orientation.

In this aspect described herein, the user may further set the orientation of the virtual object template and adjust the orientation of the virtual object template based on the candidate orientations provided by the terminal, so that the user can independently adjust an orientation of the virtual object template, thereby making the overall posture of the virtual object template more vivid and interesting. When the posture of the virtual object template is subsequently applied to the target virtual object, the orientation of the target virtual object is synchronously adjusted to the orientation of the virtual object template, thereby making the overall posture of the target virtual object more vivid and interesting.

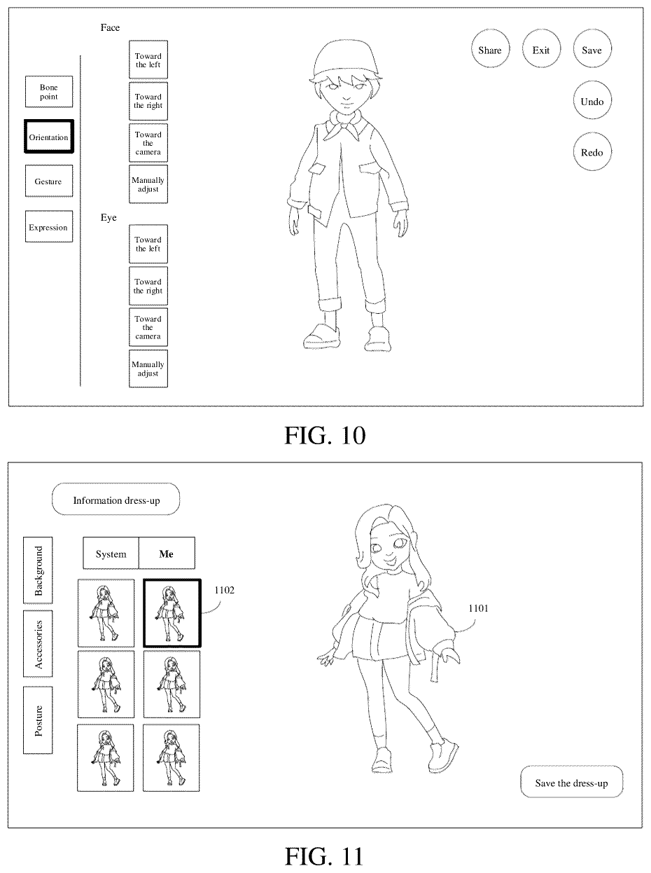

FIG. 10 is a schematic diagram of another posture editing interface according to an aspect described herein. As shown in FIG. 10, an orientation setting option “Orientation” is displayed in the posture editing interface. After the user performs a trigger operation on the orientation setting option, the terminal displays, on the left side of the posture editing interface, a plurality of candidate orientations for a face, an orientation adjustment option “Manually adjust” for the face, a plurality of candidate orientations for an eye, and an orientation adjustment option “Manually adjust” for the eye.

306: The terminal generates posture data of a first posture based on the virtual object template in the first posture in response to a posture generation request for the virtual object template.

When the posture of the virtual object template reaches a posture satisfactory to the user, the user stops performing the posture editing operation and performs the posture generation operation on the virtual object template to trigger the posture generation request. The terminal generates the posture data of the first posture based on the virtual object template in the first posture in response to the posture generation request the posture data being configured for indicating the first posture.

In a possible implementation, the posture data of the first posture includes at least one of a posture name, creator information, a creation time, body shape information, an initial posture identifier, a bone point movement parameter, gesture information, expression information, orientation information, and a posture preview image. The creator information is information of an account that creates the posture, the body shape information is a body shape to which the virtual object template used during the creation of the posture belongs, the initial posture identifier indicates an initial posture of the virtual object template used during the creation of the posture, the bone point movement parameter indicates a rotation direction and a rotation angle of each bone point, the gesture information indicates a gesture set for the virtual object template during the creation of the posture, the expression information indicates an expression set for the virtual object template during the creation of the posture, the orientation information indicates an orientation set for the virtual object template during the creation of the posture, and the posture preview image is an image of the virtual object template in the posture, an orientation of the virtual object template in the posture preview image being toward a camera.

307: The terminal displays, in response to a posture application request for applying the posture of the virtual object template to a target virtual object, the target virtual object in the first posture in an object display interface of the target virtual object based on the posture data.

After generating posture data based on the virtual object template in the first posture, the user may apply the posture of the virtual object template to the target virtual object. The user performs a posture application operation to apply the posture of the virtual object template to the target virtual object, thereby triggering the posture application request. The terminal obtains the posture data of the first posture and displays the target virtual object in the first posture in the object display interface based on the posture data in response to the posture application request. The terminal may drive the target virtual object based on the posture data, to obtain the target virtual object in the first posture.

In a possible implementation, the target virtual object is a virtual object controlled by an account currently logged in the terminal. The current terminal may display the object display interface of the target virtual object, and other terminals of other accounts logged in the game application may also display the object display interface of the target virtual object. After applying the first posture to the target virtual object, the current terminal displays the target virtual object in the first posture in the object display interface of the target virtual object, and other terminals also display the target virtual object in the first posture in the object display interface of the target virtual object, thereby ensuring a consistent posture of the target virtual object. In a possible implementation, after generating the posture data of the first posture, the terminal uploads the posture data to a game server. The terminal further forwards the posture application request to the game server in response to the posture application request for applying the first posture to the target virtual object. The game server has an association relationship between an object identifier of the target virtual object and a posture identifier of the first posture stored therein. When receiving a view request for the target virtual object from another terminal, the server may determine through query that the object identifier of the target virtual object is associated with the posture identifier of the first posture, indicating that the current target virtual object is in the first posture. Therefore, the server transmits the posture data of the first posture to the another terminal, so that the another terminal displays the target virtual object in the first posture in the object display interface of the target virtual object based on the posture data of the first posture. In this way, any user can view postures customized by other users.

In a possible implementation, the posture data includes an initial posture identifier and a first bone point movement parameter, the initial posture identifier indicating a first initial posture, the first initial posture being the initial posture of the virtual object template, and the first bone point movement parameter being configured for adjusting the first initial posture to the first posture.

In this case, that the terminal displays the target virtual object in the first posture in the object display interface of the target virtual object based on the posture data includes: obtaining, by the terminal based on the initial posture identifier, a stored second bone point movement parameter, the second bone point movement parameter being configured for adjusting a second initial posture to the first initial posture, the second initial posture being an initial posture of the target virtual object; and switching, by the terminal, a posture of the target virtual object in the object display interface to the first posture based on the first bone point movement parameter and the second bone point movement parameter.

The initial posture identifier in the posture data indicates the first initial posture of the virtual object template used during the creation of the posture. The first bone point movement parameter includes a rotation direction and a rotation angle of rotation that needs to be performed on each bone point during adjustment from the first initial posture to the first posture. When the first posture needs to be applied to the target virtual object, the second initial posture of the target virtual object is first determined. Both the first initial posture and the second initial posture are postures preset in the game application. Therefore, the terminal obtains the second bone point movement parameter. The second bone point movement parameter includes a rotation direction and a rotation angle of rotation that needs to be performed on each bone point when during adjustment from the second initial posture to the first initial posture. The terminal switches the posture of the target virtual object from the second initial posture to the first initial posture based on the second bone point movement parameter, then switches the posture of the target virtual object from the first initial posture to the first posture based on the first bone point movement parameters, and displays the target virtual object in the first posture in the object display interface.

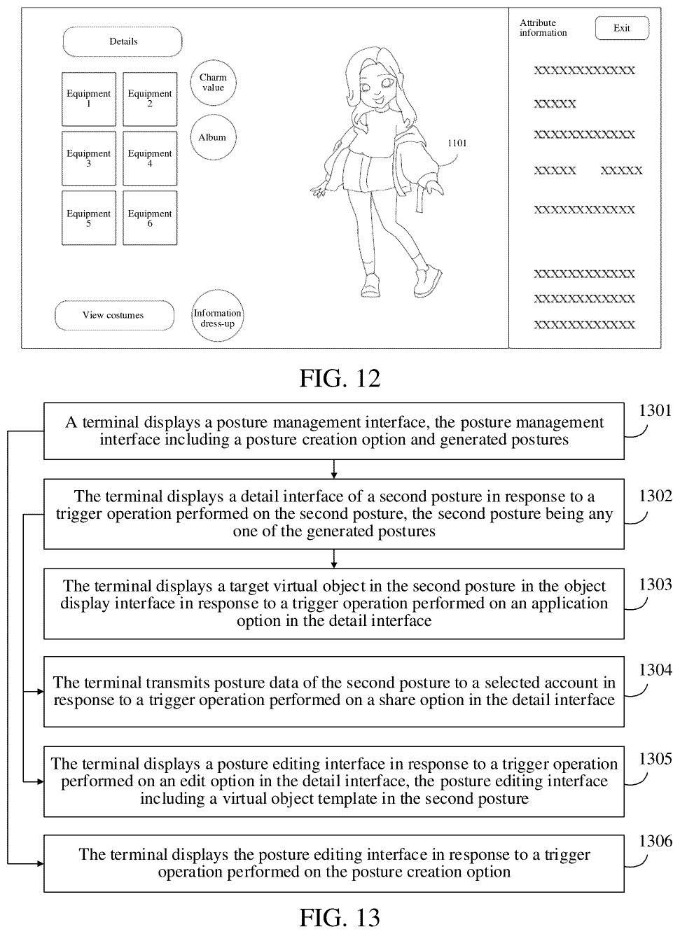

FIG. 11 is a schematic diagram of a posture setting interface according to an aspect described herein. As shown in FIG. 11, in the posture setting interface, a posture of a target virtual object 1101 (e.g., a virtual character as shown in FIG. 11) may be set. A plurality of generated postures are displayed in the posture setting interface. If the user wants to apply a posture 1102 of the plurality of postures to the target virtual object 1101, the user performs a selection operation on the posture 1102. The terminal sets the posture of the target virtual object 1101 to the posture 1102 in response to the selection operation performed on the posture 1102. The user performs a trigger operation on a “Save the dress-up” option in the posture setting interface. The terminal displays an object display interface as shown in FIG. 12 in response to the trigger operation. As shown in FIG. 12, the terminal displays the target virtual object 1101 in the posture 1102 in the object display interface. In addition, equipment and attribute information of the target virtual object 1101 are further displayed in the object display interface.

In related technologies, during virtual object display in an object display interface, the virtual objects are usually in fixed postures preset in a game application, lacking a personalization space for users. In this aspect described herein, the user may perform editing based on the initial postures in the game application to obtain customized postures, and virtual objects in the customized postures may be displayed in the object display interface. Therefore, during virtual object display in the object display interface, not only rich appearances and attribute information of the virtual objects can be presented, but also customized postures can be independently set, thereby satisfying personalized requirements of numerous users.

According to the method provided in this aspect described herein, the user may first edit a customized posture by using the virtual object template, perform the posture editing operation on the virtual object template, to flexibly generate various postures, and subsequently apply the generated posture to the target virtual object controlled by the user, to display the target virtual object in the customized posture in the object display interface. Therefore, the user can flexibly set the posture of the target virtual object displayed in the object display interface, which improves flexibility of the posture of the virtual object during display of the virtual object and enhances a display effect of the virtual object.

Based on the foregoing aspect, after creating the customized posture, the user may further apply the customized posture, edit the customized posture, and share the customized posture. For a detailed process, reference is made to the following aspect shown in the FIG. 13. FIG. 13 is a flowchart of another posture editing method for a virtual object according to an aspect described herein. This aspect described herein is executed by a terminal. Referring to FIG. 13, the method includes the following operations.

1301: The terminal displays a posture management interface, the posture management interface including a posture creation option and generated postures.

The posture management interface is configured to manage customized postures. The posture management interface includes the posture creation option and the generated postures. The generated postures include postures created by the currently logged account, and may further include postures shared by other accounts to the currently logged account. In some aspects, displaying a posture refers to displaying an image of the posture, displaying a name of the posture, or the like.

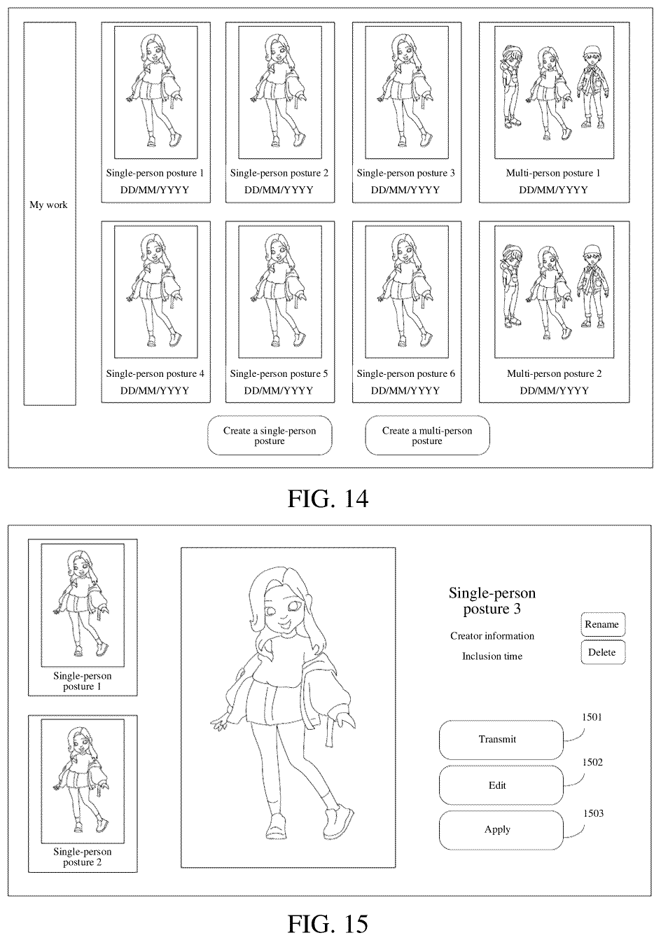

FIG. 14 is a schematic diagram of a posture management interface according to an aspect described herein. As shown in FIG. 14, the posture management interface includes a plurality of generated postures and a creation time of each posture. The postures include single-person postures and multi-person postures (for a process of generating the multi-person postures, reference is made to the following aspect shown in the FIG. 17). A posture creation option is further displayed in the posture management interface. As shown in FIG. 14, the posture creation option includes a “Create a single-person posture” option and a “Create a multi-person posture” option. The “Create a single-person posture” option is configured for requesting to create a single-person posture, and the “Create a multi-person posture” option is configured for requesting to create a multi-person posture.

1302: The terminal displays a detail interface of a second posture in response to a trigger operation performed on the second posture, the second posture being any one of the generated postures.

If the user wants to view details of the second posture, the user performs the trigger operation on the second posture. The terminal displays the detail interface of the second posture in response to the trigger operation. In some aspects, the detail interface includes a posture preview image, a posture name, creator information, and a creation time of the second posture, a share option, an edit option, and an application option.

The second posture is any one of the generated postures. For example, the second posture may be a posture generated by the currently logged account, or may include postures shared by other accounts to the currently logged account, which is not limited in this aspect described herein.

FIG. 15 is a schematic diagram of a detail interface according to an aspect described herein. As shown in FIG. 15, the detail interface is a detail interface of a single-person posture 3. The detail interface includes a posture preview image, a posture name, creator information, and a creation time of the single-person posture 3, as well as a share option 1501, an edit option 1502, and an application option 1503. In addition, the detail interface also includes a rename option and a delete option.

1303: The terminal displays a target virtual object in the second posture in the object display interface in response to a trigger operation performed on an application option in the detail interface.

The detail interface includes an application option, which is configured for requesting to apply the second posture to a virtual object controlled by the currently logged account. If the user wants to apply the second posture to the target virtual object, the user performs the trigger operation on the application option in the detail interface. In some aspects, in response to the trigger operation, the terminal obtains posture data of the second posture, drives the target virtual object to be in the second posture based on the posture data of the second posture, and displays the target virtual object in the second posture in the object display interface of the target virtual object.

1304: The terminal transmits posture data of the second posture to a selected account in response to a trigger operation performed on a share option in the detail interface.

The detail interface includes a share option, which is configured for requesting to share the second posture with other accounts. If the user wants to share the second posture with the other accounts, the user performs a trigger operation on the share option in the detail interface. The terminal displays associated accounts that have an association relationship with the currently logged account in response to the trigger operation, and transmits, in response to a selection operation performed on any one of the associated accounts, the posture data of the second posture to the selected associated account. After receiving the posture data of the second posture, a terminal of the associated account may import the second posture into a posture management interface of the associated account, that is, display the second posture in the posture management interface of the associated account. Subsequently, the associated account may apply the second posture to a virtual object controlled by the associated account.

In this aspect described herein, the user may share the customized posture created by the user with friends, and the friends may directly apply the customized posture created by the user to virtual objects thereof, to achieve sharing of the customized posture, which not only helps improve a utilization rate of the customized posture, but also promotes interaction among users in the game application, expands posture sharing manners in socialization, and enhances fun of the game application.

1305: The terminal displays a posture editing interface in response to a trigger operation performed on an edit option in the detail interface, the posture editing interface including a virtual object template in the second posture.

The detail interface includes an edit option, which is configured for requesting to edit a generated posture. If the user wants to further improve the generated second posture, the user performs the trigger operation on the edit option in the detail interface. The terminal jumps to the posture editing interface and displays the virtual object template in the second posture in the posture editing interface in response to the trigger operation. The user may further edit the second posture on the virtual object template in the posture editing interface in a manner same as that in the foregoing process of operation 302 to operation 306. Details are not described herein.

1306: The terminal displays the posture editing interface in response to a trigger operation performed on the posture creation option.

The posture management interface provides the posture creation option. If the user wants to create a customized posture, the user performs the trigger operation on the posture creation option. The terminal switches from the posture management interface to the posture editing interface in response to the trigger operation performed on the posture creation option. For a process of editing the posture in the posture editing interface, reference is made to the foregoing aspect shown in FIG. 3. Details are not described herein.

In a possible implementation, the terminal displays a confirmation interface in response to the trigger operation performed on the posture creation option. The confirmation interface includes prompt information, a confirmation option, and a cancel option. The prompt information is configured for prompting whether to jump to the posture editing interface, the confirmation option is configured for confirming jumping to the posture editing interface, and the cancel option is configured to cancel jumping to the posture editing interface. In this aspect described herein, displaying the confirmation interface for secondary confirmation by the user can prevent accidental trigger of the user.

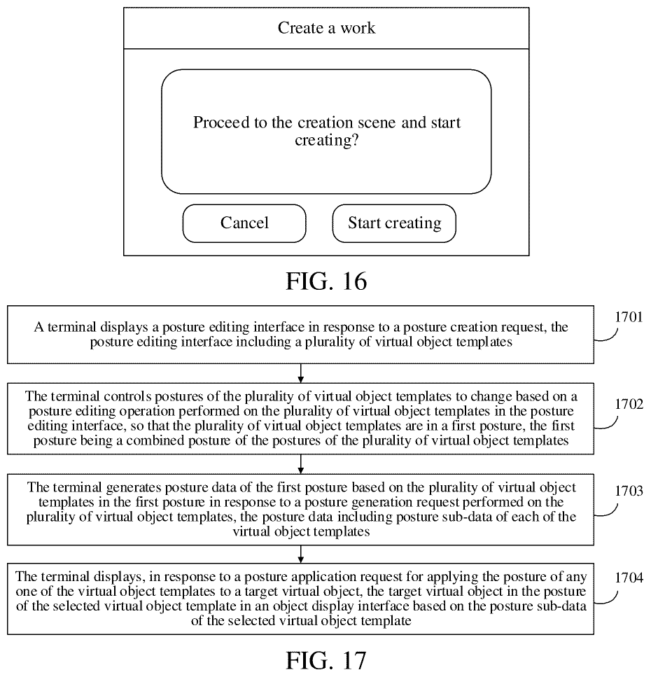

FIG. 16 is a schematic diagram of a confirmation interface according to an aspect described herein. As shown in FIG. 16, prompt information “Proceed to the creation scene and start creating?” is displayed in the confirmation interface, and a confirmation option “Start creating” and a cancel option “Cancel” are further displayed in the confirmation interface.

According to the method provided in this aspect described herein, the user may share the customized posture created by the user with friends, and the friends may directly apply the customized posture created by the user to virtual objects thereof, to achieve sharing of the customized posture, which not only helps improve a utilization rate of the customized posture, but also promotes interaction among users in the game application, expands posture sharing manners in socializing, and enhances fun of the game application.

The foregoing aspect shown in FIG. 3 is described only by using creation of a single-person posture as an example. The user may further create a multi-person posture. For a detailed process, reference is made to the following aspect shown in FIG. 17. FIG. 17 is a flowchart of another posture editing method for a virtual object according to an aspect described herein. This aspect described herein is executed by a terminal. Referring to FIG. 17, the method includes the following operations.

1701: The terminal displays a posture editing interface in response to a posture creation request, the posture editing interface including a plurality of virtual object templates.

The terminal displays a plurality of virtual object templates in the posture editing interface in response to a multi-person posture creation request. A user may directly edit postures of the plurality of virtual object templates in the posture editing interface to form a combined posture.

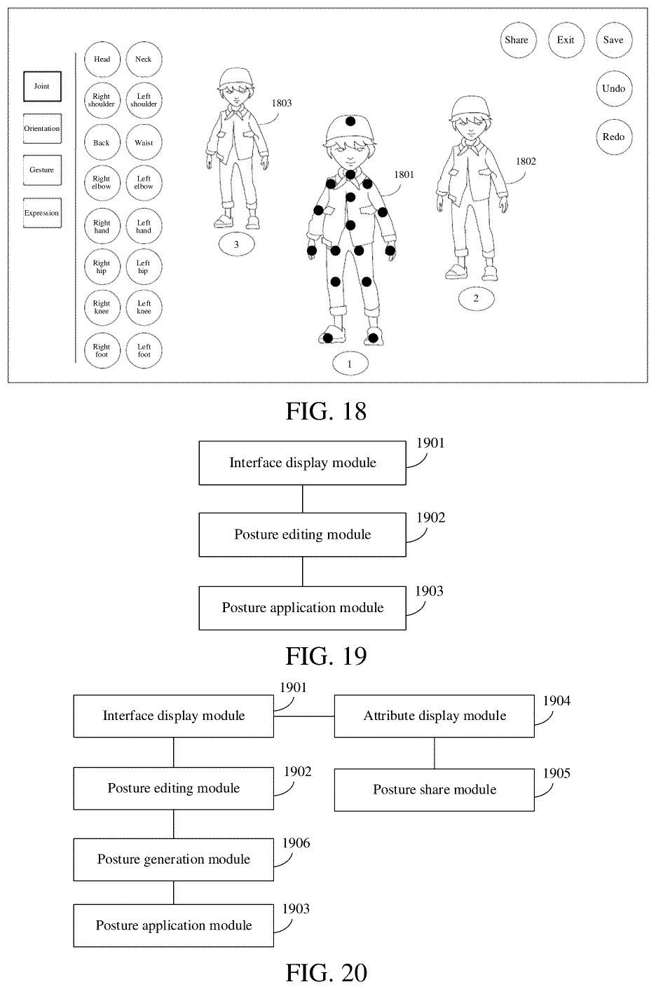

FIG. 18 is a schematic diagram of another posture editing interface according to an aspect described herein. As shown in FIG. 18, the posture editing interface includes three virtual object templates, i.e., a virtual object template 1801, a virtual object template 1802, and a virtual object template 1803.

1702: The terminal controls postures of the plurality of virtual object templates to change based on a posture editing operation performed on the plurality of virtual object templates in the posture editing interface, so that the plurality of virtual object templates are in a first posture, the first posture being a combined posture of the postures of the plurality of virtual object templates.

The posture editing operation performed on the plurality of virtual object templates includes a posture editing operation separately performed on each of the virtual object templates. The terminal displays the plurality of virtual object templates in the posture editing interface, and switches, in response to a trigger operation performed on any one of the virtual object templates, the selected virtual object template from a non-editable state to an editable state. The user performs a posture editing operation on the virtual object template in the editable state in the posture editing interface. The terminal controls the posture of the virtual object template in the editable state to change in response to the posture editing operation performed on the virtual object template in the editable state. The user may sequentially switch the plurality of virtual object templates to the editable state for editing, to separately perform a posture editing operation on each of the virtual object templates, so that the terminal controls the posture of each of the virtual object templates to change. The postures of the plurality of virtual object templates after the change form the first posture, which is the combined posture of the postures of the plurality of virtual object templates. A process of performing the posture editing on any one of the virtual object templates by the user is the same as the foregoing process of operation 302 to operation 305. Details are not described herein.

For example, as shown in FIG. 18, in a case that the virtual object template 1801 is in the editable state, the virtual object template 1801 is displayed in a central area of the posture editing interface, and bone points are displayed on a body of the virtual object template 1801, so that the user performs an adjustment operation on the bone points of the virtual object template 1801.

1703: The terminal generates posture data of the first posture based on the plurality of virtual object templates in the first posture in response to a posture generation request performed on the plurality of virtual object templates, the posture data including posture sub-data of each of the virtual object templates.

The posture sub-data of the virtual object template indicates a posture of the virtual object template. A process of operation 1703 is the same as the foregoing process of operation 306. Details are not described herein.

1704: The terminal displays, in response to a posture application request for applying the posture of any one of the virtual object templates to a target virtual object, the target virtual object in the posture of the selected virtual object template in an object display interface based on the posture sub-data of the selected virtual object template.

The target virtual object is a virtual object in the game application operated and controlled by the user. If the user wants to apply the posture of a virtual object template to the target virtual object, the user performs the posture application operation to apply the posture of the virtual object template to the target virtual object, to trigger posture application request. The terminal obtains the posture sub-data of the virtual object template and displays the target virtual object in the posture of the virtual object template in the object display interface based on the posture sub-data in response to the posture application request. A process of operation 1704 is the same as the foregoing process of operation 307. Details are not described herein.

After applying the posture of the virtual object template to the target virtual object, other virtual objects may apply the postures of the other virtual object templates, so that the plurality of virtual objects form the first posture. For example, the first posture is formed by postures of three virtual object templates, i.e., a posture x of a virtual object template 11, a posture y of a virtual object template 12, and a posture z of a virtual object template 13. A currently logged account is an account A. The account A has a target virtual object 21. After the account A applies the posture x of the virtual object template 1 to the target virtual object 21, the target virtual object 21 in the posture x is displayed on the object display interface, and the posture y and the posture y z are also displayed on the object display interface. An account B has a target virtual object 22. The account B may apply the posture y of the virtual object template 12 to the target virtual object 22 in the object display interface. The account C possesses a target virtual object 23. The account C may apply the posture z of the virtual object template 13 to the target virtual object 23 in the object display interface. The target virtual object 21 in the posture x, the target virtual object 22 in the posture y, and the target virtual object 23 in the posture z are displayed in the object display interface. Therefore, the target virtual object 21, the target virtual object 22, and the target virtual object 23 form the first posture, achieving the application of the first posture to a plurality of virtual objects.

According to the method provided in this aspect described herein, the user can edit the postures of a plurality of virtual object templates, the postures of the plurality of virtual object templates forming the combined posture, to flexibly generate various postures. The user may apply a posture of the combined posture to the virtual object thereof, to display the target virtual object in a customized posture in the object display interface. Therefore, the user can flexibly set the posture of the target virtual object displayed in the object display interface, which improves flexibility of the posture of the virtual object during display of the virtual object and enhances a display effect of the virtual object.

FIG. 19 is a schematic structural diagram of a posture editing apparatus for a virtual object according to an aspect described herein. Referring to FIG. 19, the apparatus includes:
an interface display module 1901, configured to display a posture editing interface in response to a posture creation request, the posture editing interface including a virtual object template;
a posture editing module 1902, configured to control a posture of the virtual object template to change based on a posture editing operation performed on the virtual object template in the posture editing interface, so that the virtual object template is in a first posture; and
a posture application module 1903, configured to display, in response to a posture application request for applying the posture of the virtual object template to a target virtual object, the target virtual object in the first posture in an object display interface of the target virtual object.

According to the posture editing apparatus for a virtual object provided in this aspect described herein, the user may first edit a customized posture by using the virtual object template, perform the posture editing operation on the virtual object template, to flexibly generate various postures, and subsequently apply the generated posture to the target virtual object controlled by the user, to display the target virtual object in the customized posture in the object display interface. Therefore, the user can flexibly set the posture of the target virtual object displayed in the object display interface, which improves flexibility of the posture of the virtual object during display of the virtual object and enhances a display effect of the virtual object.

In some aspects, bone points of the virtual object template are further displayed in the posture editing interface. The posture editing module 1902 is configured to:
switch, in response to a selection operation performed on a target bone point of the virtual object template, the target bone point from a non-editable state to an editable state, the target bone point being any one of the bone points of the virtual object template; and
control, in response to an adjustment operation performed on the target bone point, the target bone point to move based on the adjustment operation.

In some aspects, the posture editing module 1902 is configured to control, in response to a drag operation performed in the posture editing interface, the target bone point to move in a direction of the drag operation,
the drag operation being a drag operation performed on the target bone point or a drag operation performed on a virtual joystick in the posture editing interface.

In some aspects, the posture editing module 1902 is configured to:
determine an associated bone point of the target bone point and control the target bone point and the associated bone point to move in response to the drag operation when the posture editing interface is in a first mode, so that the target bone point displaces based on the drag operation, the first mode being configured for controlling the bone points of the virtual object template to displace; and
control the target bone point to rotate based on the drag operation in response to the drag operation when the posture editing interface is in a second mode, the second mode being configured for controlling the bone points of the virtual object template to rotate.

In some aspects, the posture editing module 1902 is configured to stop, during control of any one of the bone points to rotate, controlling rotation of the bone point in a current direction in a case that a rotation angle of the bone point in the current direction reaches a rotation angle threshold of the bone point in the current direction.

In some aspects, the posture editing module 1902 is configured to display a direction indication mark in response to the selection operation performed on the target bone point, the direction indication mark being configured for indicating a moving direction allowed for the target bone point, the moving direction including at least one of a displacement direction and a rotation direction.

In some aspects, the direction indication mark is composed of the direction indication mark is composed of indication sub-marks of a plurality of moving directions, each indication sub-mark being configured for indicating one moving direction. The posture editing module 1902 is further configured to cancel, in response to a drag operation performed in the posture editing interface, display of indication sub-marks other than an indication sub-mark of a target direction, the target direction being a direction of the drag operation.

In some aspects, the posture editing interface further includes a gesture setting option. The posture editing module 1902 is further configured to:
display a plurality of candidate gestures in the posture editing interface in response to a trigger operation performed on the gesture setting option; and
adjust, in response to a selection operation performed on any one of the candidate gestures, a gesture of the virtual object template to the selected candidate gesture.

In some aspects, the posture editing interface further includes an expression setting option. The posture editing module 1902 is further configured to:
display a plurality of candidate expressions in the posture editing interface in response to a trigger operation performed on the expression setting option; and
adjust, in response to a selection operation performed on any one of the candidate expressions, an expression of the virtual object template to the selected candidate expression.

In some aspects, the posture editing interface further includes an orientation setting option. The posture editing module 1902 is further configured to:
display a plurality of candidate orientations in the posture editing interface in response to a trigger operation performed on the orientation setting option; and
adjust, in response to a selection operation performed on any one of the candidate orientations, an orientation of the virtual object template to the selected candidate orientation.

In some aspects, the interface display module 1901 is configured to:
display a posture management interface, the posture management interface including a posture creation option and generated postures; and
display the posture editing interface in response to a trigger operation performed on the posture creation option.

In some aspects, referring to FIG. 20, the apparatus further includes an attribute display module 1904 configured to display a detail interface of a second posture in response to a trigger operation performed on the second posture, the second posture being any one of the generated postures.

The apparatus further includes any one of the following:
a posture application module 1903, configured to display, when the detail interface includes an application option, the target virtual object in the second posture in the object display interface in response to a trigger operation performed on the application option;
a posture share module 1905, configured to transmit, when the detail interface includes a share option, posture data of the second posture to a selected account in response to a trigger operation performed on the share option; and
an interface display module 1901, configured to display, when the detail interface includes an edit option, the posture editing interface in response to a trigger operation performed on the edit option, the posture editing interface including a virtual object template in the second posture.

In some aspects, the interface display module 1901 is configured to:
display a plurality of candidate postures in the posture editing interface in response to the posture creation request; and
display, in response to a selection operation performed on any one of the candidate postures, a virtual object template in the selected candidate posture in the posture editing interface.

In some aspects, the apparatus further includes:
a posture generation module 1906, configured to generate posture data of the first posture based on the virtual object template in the first posture in response to a posture generation request for the virtual object template; and
a posture application module 1903, configured to display the target virtual object in the first posture in the object display interface of the target virtual object based on the posture data in response to the posture application request.

In some aspects, the posture data includes an initial posture identifier and a first bone point movement parameter, the initial posture identifier indicating a first initial posture, the first initial posture being an initial posture of the virtual object template, and the first bone point movement parameter being configured for adjusting the first initial posture to the first posture.

The posture application module 1903 is configured to:
obtain, based on the initial posture identifier, a stored second bone point movement parameter, the second bone point movement parameter being configured for adjusting a second initial posture to the first initial posture, the second initial posture being an initial posture of the target virtual object; and
switch a posture of the target virtual object in the object display interface to the first posture based on the first bone point movement parameter and the second bone point movement parameter.

In some aspects, the posture editing interface includes a plurality of virtual object templates, and the first posture is a combined posture of postures of the plurality of virtual object templates.

The posture application module 1903 is configured to:
display, in response to a posture application request for applying a posture of any one of the virtual object templates to the target virtual object, the target virtual object in a posture of the selected virtual object template in the object display interface.

The posture editing apparatus for a virtual object provided in the foregoing aspect is described only with an example of division of the foregoing functional modules. In practical application, the functions may be allocated to and completed by different function modules as required. To be specific, an internal structure of a computer device is divided into different functional modules to complete all or some of the functions described above. In addition, the posture editing apparatus for a virtual object provided in the foregoing aspect and the aspect of the posture editing method for a virtual object belong to the same idea. Therefore, for a specific implementation process of the posture editing apparatus for a virtual object, reference is made to the method aspects. Details are not described herein.

An aspect described herein further provides a computer device, the computer device including a processor and a memory, the memory having at least one computer program stored therein, the at least one computer program being loaded and executed by the processor to implement the operations performed in the posture editing method for a virtual object in the foregoing aspect.

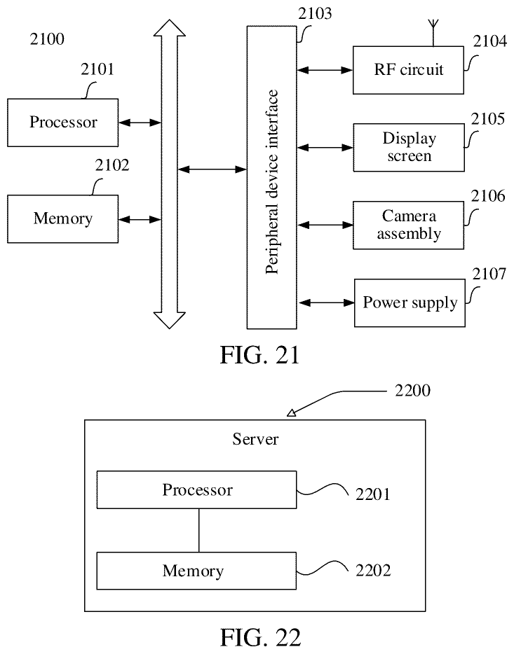

In some aspects, the computer device is provided as a terminal. FIG. 21 is a schematic structural diagram of a terminal 2100 according to an illustrative aspect described herein. The terminal 2100 includes a processor 2101 and a memory 2102.

The processor 2101 may include one or more processing cores, for example, a 4-core processor or an 8-core processor. The processor 2101 may be implemented by using at least one of the following hardware forms: a digital signal processor (DSP), a field-programmable gate array (FPGA), and a programmable logic array (PLA). The processor 2101 may alternatively include a main processor and a coprocessor. The main processor is a processor configured to process data in an awake state, and is also referred to as a central processing unit (CPU). The coprocessor is a low power processor configured to process data in a standby state. In some aspects, the processor 2101 may have a graphics processing unit (GPU) integrated therein. The GPU is configured to render and draw content that needs to be displayed on a display screen. In some aspects, the processor 2101 may further include an AI processor. The AI processor is configured to process computing operations related to machine learning.

The memory 2102 may include one or more computer-readable storage media. The computer-readable storage medium may be non-transient. The memory 2102 may further include a high-speed random access memory and a nonvolatile memory, for example, one or more disk storage devices or flash storage devices. In some aspects, the non-transient computer-readable storage medium in the memory 2102 is configured to store at least one computer program, the at least one computer program being configured to be executed by the processor 2101 to implement the posture editing method for a virtual object provided in the method aspect described herein.

In some aspects, the terminal 2100 may further include a peripheral device interface 2103 and at least one peripheral device. The processor 2101, the memory 2102, and the peripheral device interface 2103 may be connected through a bus or a signal line. Each peripheral device may be connected to the peripheral device interface 2103 through a bus, a signal line, or a circuit board. In some aspects, the peripheral device includes at least one of a radio frequency (RF) circuit 2104, a display screen 2105, a camera assembly 2106, and a power supply 2107.

The peripheral device interface 2103 may be configured to connect the at least one peripheral device related to input/output (I/O) to the processor 2101 and the memory 2102. In some aspects, the processor 2101, the memory 2102, and the peripheral device interface 2103 are integrated on the same chip or the same circuit board. In some other aspects, any one or two of the processor 2101, the memory 2102, and the peripheral device interface 2103 may be implemented on a separate chip or a separate circuit board, which is not limited in this aspect.

The RF circuit 2104 is configured to receive and transmit an RF signal, which is also referred to as an electromagnetic signal. The RF circuit 2104 communicates with a communication network and other communication devices through the electromagnetic signal. The RF circuit 2104 converts an electric signal into an electromagnetic signal for transmission, or converts a received electromagnetic signal into an electric signal. In some aspects, the RF circuit 2104 includes an antenna system, an RF transceiver, one or more amplifiers, a tuner, an oscillator, a DSP, a codec chipset, a subscriber identity module card, and the like. The RF circuit 2104 may communicate with other devices through at least one wireless communication protocol. The wireless communication protocol includes, but is not limited to a metropolitan area network, various generations of mobile communication networks (2G, 3G, 4G, and 5G), a wireless local area network, and/or a wireless fidelity (Wi-Fi) network. In some aspects, the RF 2104 may further include a circuit related to near field communication (NFC), which is not limited in this application.

The display screen 2105 is configured to display a user interface (UI). The UI may include a graph, text, an icon, a video, and any combination thereof. When the display screen 2105 is a touch display screen, the display screen 2105 further has a capability of collecting a touch signal on or above a surface of the display screen 2105. The touch signal may be inputted to the processor 2101 as a control signal for processing. In this case, the display screen 2105 may be further configured to provide a virtual button and/or a virtual keyboard, which is also referred to as a soft button and/or a soft keyboard. In some aspects, one display screen 2105 may be provided, which is arranged on a front panel of the terminal 2100. In some other aspects, at least two display screen 2105 may be provided, which are respectively arranged on different surfaces of the terminal 2100 or in a folded design. In some still other aspects, the display screen 2105 may be a flexible display screen, which is arranged on a curved surface or a folded surface of the terminal 2100. The display screen 2105 even may be arranged in an irregular non-rectangular pattern, that is, be a special-shaped screen. The display screen 2105 may be made of materials such as a liquid crystal display (LCD) or an organic light-emitting diode (OLED).

The camera assembly 2106 is configured to capture an image or a video. In some aspects, the camera assembly 2106 includes a front camera and a rear camera. The front camera is arranged on the front panel of the terminal 2100, and the rear camera is arranged on a rear surface of the terminal 2100. In some aspects, at least two rear cameras are arranged, which are respectively any one of a main camera, a depth-of-field camera, a wide-angle camera, and a telephoto camera, to achieve background blur through fusion of the main camera and the depth-of-field camera, panoramic photographing and virtual reality (VR) photographing through fusion of the main camera and the wide-angle camera, or another fusion photographing function. In some aspects, the camera assembly 2106 may further include a flash. The flash may be a single color temperature flash, or may be a double color temperature flash. The double color temperature flash refers to a combination of a warm light flash and a cold light flash, and may be configured for light compensation under different color temperatures.

The power supply 2107 is configured to supply power to the components in the terminal 2100. The power supply 2107 may be an alternating current, a direct current, a disposable battery, or a rechargeable battery. When the power supply 2107 includes a rechargeable battery, the rechargeable battery may support wired charging or wireless charging. The rechargeable battery may be further configured to support a fast charging technology.

A person skilled in the art may understand that the structure shown in FIG. 21 does not constitute a limitation on the terminal 2100, and the terminal may include more or fewer components than those shown in the figure, or some merged components, or different component arrangements.

In some aspects, the computer device is provided as a server. FIG. 22 is a schematic structural diagram of a server according to an aspect described herein. The server 2200 may vary greatly in configuration or performance, and may include one or more CPUs 2201 and one or more memories 2202. The memory 2202 has at least one computer program stored therein, the at least one computer program being loaded and executed by the processor 2201 to implement the method provided in the foregoing method aspect. Certainly, the server may further have components such as a wired or wireless network interface, a keyboard, and an I/O interface, to perform input and output. The server may further include another component configured to implement a device function. Details are not described herein.

An aspect described herein further provides a computer-readable storage medium, having at least one computer program stored therein, the at least one computer program being loaded and executed by a processor to implement the operations performed in the posture editing method for a virtual object in the foregoing aspect.

An aspect described herein further provides a computer program product, including a computer program, the computer program being loaded and executed by a processor, to implement the operations performed in the posture editing method for a virtual object in the foregoing aspect.

A person of ordinary skill in the art may understand that all or some of the operations of the foregoing aspect may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely illustrative aspects of the aspects described herein, and are not intended to limit the aspects described herein. Any modification, equivalent replacement, improvement, or the like made within the spirit and principle of the aspects described herein shall fall within the protection scope described herein.

What is claimed is:

1. A method comprising:
displaying a posture editing interface in response to a posture creation request, the posture editing interface comprising a virtual object template depicting a virtual object in an initial posture;
adjusting the virtual object template based on one or more received posture editing operations performed on the virtual object template in the posture editing interface, resulting in the virtual object template being in a first posture; and
displaying, responsive to a posture application request for applying the posture of the virtual object template to a target virtual object, the target virtual object in the first posture in an object display interface.

2. The method according to claim 1, wherein bone points of the virtual object template are further displayed in the posture editing interface; and the adjusting comprises:
switching, in response to a selection operation performed on a target bone point of the virtual object template, the target bone point from a non-editable state to an editable state, the target bone point being a bone point of the virtual object template selected by the selection operation; and
controlling, in response to an adjustment operation performed on the target bone point, the target bone point to move based on the adjustment operation.

3. The method according to claim 2, wherein the controlling, in response to an adjustment operation performed on the target bone point, the target bone point to move based on the adjustment operation comprises:
controlling, in response to a drag operation performed in the posture editing interface, the target bone point to move in a direction of the drag operation,
the drag operation being a drag operation performed on the target bone point or a drag operation performed on a virtual joystick in the posture editing interface.

4. The method according to claim 3, wherein the controlling in response to the drag operation comprises:
determining an associated bone point of the target bone point and controlling the target bone point and the associated bone point to move in response to the drag operation when the posture editing interface is in a first mode, so that the target bone point displaces based on the drag operation, the first mode being configured for controlling the bone points of the virtual object template to displace; and
controlling the target bone point to rotate based on the drag operation in response to the drag operation when the posture editing interface is in a second mode, the second mode being configured for controlling the bone points of the virtual object template to rotate.

5. The method according to claim 4, further comprising:
stopping, during control of any one of the bone points to rotate, controlling rotation of the bone point in a current direction in a case that a rotation angle of the bone point in the current direction reaches a predetermined rotation angle threshold of the bone point in the current direction.

6. The method according to claim 2, further comprising:
displaying a direction indication mark in response to the selection operation performed on the target bone point, the direction indication mark being configured for indicating a moving direction allowed for the target bone point, the moving direction comprising at least one of a displacement direction and a rotation direction.

7. The method according to claim 6, wherein the direction indication mark is composed of indication sub-marks of a plurality of moving directions, each indication sub-mark being configured for indicating one moving direction, and the method further comprises:
canceling, in response to a drag operation performed in the posture editing interface, display of indication sub-marks other than an indication sub-mark of a target direction, the target direction being a direction of the drag operation.

8. The method of claim 1, wherein the posture editing interface further comprises a gesture setting option, and the adjusting comprises:
displaying a plurality of candidate gestures in the posture editing interface in response to a trigger operation performed on the gesture setting option; and
adjusting, in response to a selection operation performed on any one of the candidate gestures, a gesture of the virtual object template to the selected candidate gesture.

9. The method of claim 1, wherein the posture editing interface further comprises an expression setting option, and the adjusting comprises:
displaying a plurality of candidate expressions in the posture editing interface in response to a trigger operation performed on the expression setting option; and
adjusting, in response to a selection operation performed on any one of the candidate expressions, an expression of the virtual object template to the selected candidate expression.

10. The method of claim 1, wherein the posture editing interface further comprises an orientation setting option, and the adjusting comprises:
displaying a plurality of candidate orientations in the posture editing interface in response to a trigger operation performed on the orientation setting option; and
adjusting, in response to a selection operation performed on any one of the candidate orientations, an orientation of the virtual object template to the selected candidate orientation.

11. The method of claim 1, wherein the displaying a posture editing interface in response to a posture creation request comprises:
displaying a posture management interface, the posture management interface comprising a posture creation option and generated postures; and
displaying the posture editing interface in response to a trigger operation performed on the posture creation option.

12. The method of claim 11, further comprising:
displaying a detail interface of a second posture in response to a trigger operation performed on the second posture, the second posture being any one of the generated postures; and
the method further comprising one or more of the following:
displaying, when the detail interface comprises an application option, the target virtual object in the second posture in the object display interface in response to a trigger operation performed on the application option;
transmitting, when the detail interface comprises a share option, posture data of the second posture to a selected account in response to a trigger operation performed on the share option; and
displaying, when the detail interface comprises an edit option, the posture editing interface in response to a trigger operation performed on the edit option, the posture editing interface comprising a virtual object template in the second posture.

13. The method of claim 1, wherein the displaying a posture editing interface in response to a posture creation request comprises:
displaying a plurality of candidate postures in the posture editing interface in response to the posture creation request; and
displaying, in response to a selection operation performed on any one of the candidate postures, a virtual object template in the selected candidate posture as the initial posture in the posture editing interface.

14. The method of claim 1, wherein after the adjusting, the method further comprises:
generating posture data of the first posture based on the virtual object template in the first posture in response to a posture generation request for the virtual object template; and
the displaying responsive to the posture application request comprises:
displaying the target virtual object in the first posture in the object display interface of the target virtual object based on the posture data in response to the posture application request.

15. The method according to claim 14, wherein the posture data comprises an initial posture identifier and a first bone point movement parameter, the initial posture identifier indicating a first initial posture, the first initial posture being an initial posture of the virtual object template, and the first bone point movement parameter being configured for adjusting the first initial posture to the first posture; and
the displaying the target virtual object in the first posture comprises:
obtaining, based on the initial posture identifier, a stored second bone point movement parameter, the second bone point movement parameter being configured for adjusting a second initial posture to the first initial posture, the second initial posture being an initial posture of the target virtual object; and
switching a posture of the target virtual object in the object display interface to the first posture based on the first bone point movement parameter and the second bone point movement parameter.

16. The method of claim 1, wherein the posture editing interface comprises a plurality of virtual object templates, and the first posture is a combined posture of postures of the plurality of virtual object templates; and
the displaying in response to the posture application request comprises:
displaying, in response to the posture application request for applying a posture of any one of the virtual object templates to the target virtual object, the target virtual object in a posture of the selected virtual object template in the object display interface.

17. One or more non-transitory computer readable media comprising computer readable instructions which, when executed by a processor, configure a data processing system to perform:
displaying a posture editing interface in response to a posture creation request, the posture editing interface comprising a virtual object template depicting a virtual object in an initial posture;
adjusting the virtual object template based on one or more received posture editing operations performed on the virtual object template in the posture editing interface, resulting in the virtual object template being in a first posture; and
displaying, responsive to a posture application request for applying the posture of the virtual object template to a target virtual object, the target virtual object in the first posture in an object display interface.

18. The computer readable media of claim 17, wherein bone points of the virtual object template are further displayed in the posture editing interface, and the adjusting comprises:
switching, in response to a selection operation performed on a target bone point of the virtual object template, the target bone point from a non-editable state to an editable state, the target bone point being a bone point of the virtual object template selected by the selection operation; and
controlling, in response to an adjustment operation performed on the target bone point, the target bone point to move based on the adjustment operation.

19. A system, comprising:
a processor; and
memory storing computer readable instructions which, when executed by the processor, configure the system to perform:
displaying a posture editing interface in response to a posture creation request, the posture editing interface comprising a virtual object template depicting a virtual object in an initial posture;
adjusting the virtual object template based on one or more received posture editing operations performed on the virtual object template in the posture editing interface, resulting in the virtual object template being in a first posture; and
displaying, responsive to a posture application request for applying the posture of the virtual object template to a target virtual object, the target virtual object in the first posture in an object display interface.

20. The system of claim 19, wherein bone points of the virtual object template are further displayed in the posture editing interface, and the adjusting comprises:
switching, in response to a selection operation performed on a target bone point of the virtual object template, the target bone point from a non-editable state to an editable state, the target bone point being a bone point of the virtual object template selected by the selection operation; and
controlling, in response to an adjustment operation performed on the target bone point, the target bone point to move based on the adjustment operation.
